(19) United States
(12) Patent Application Publication
(10) Pub. No.: US 2026/0227845 A1
(43) Pub. Date: Aug. 6, 2026

(54) IMMERSIVE VIBES - AI AND HAPTIC POWERED SENSORY SYSTEM

(71) Applicant: Iuliia Baiguzhova, North Miami Beach, FL (US)

(72) Inventor: Iuliia Baiguzhova, North Miami Beach, FL (US)

(21) Appl. No.: 19/418,899

(22) Filed: Dec. 12, 2025

Related U.S. Application Data
(60) Provisional application No. 63/752,501, filed on Jan. 31, 2025.

(51) Int. Cl. G06F 3/01; G06F 3/16; G06N 3/08

(52) U.S. Cl. CPC G06F 3/011; G06F 3/016; G06F 3/165; G06N 3/08

(57) ABSTRACT

The IMMERSIVE VIBES—AI AND HAPTIC POWERED SENSORY SYSTEM enables adaptive multi-sensory entertainment experiences by combining artificial intelligence, biometric sensing, audio modulation, visual generation, and haptic technology. Audience physiological and behavioral data—such as heart rate, movement, and facial expression—are analyzed by an AI engine that dynamically modifies music, imagery, lighting, and tactile feedback in real time to mirror collective and individual emotional responses. The system integrates synchronized sensory subsystems, including AR/VR visual generators, wearable haptic devices, and performer control interfaces. A hybrid physical-virtual architecture supports simultaneous participation of local and remote audiences while also delivering individualized sensory experiences to each participant. The invention establishes a unified AI-driven platform for live shows, immersive installations, and metaverse performances, transforming entertainment into a responsive, data-driven environment linking sound, vision, and touch through adaptive emotional intelligence.

### CROSS-REFERENCE TO RELATED APPLICATIONS

This application claims the benefit under 35 U.S.C. § 119(e) of U.S. Provisional Patent Application No. 63/752,501, filed Jan. 31, 2025, entitled “JOOLIA Immersive Vibes—AI-Driven Solution for Audio-Visual Live Performances & Immersive Sound Experiences with Haptic Technology Integration,” the entire contents of which are incorporated herein by reference.

### FIELD OF THE INVENTION

The present invention relates to interactive entertainment technologies, particularly to systems that combine artificial intelligence (AI), augmented or virtual reality (AR/VR), biometric feedback, and haptic devices to produce adaptive, multi-sensory live or virtual performances.

### BACKGROUND OF THE INVENTION

Conventional music and entertainment systems—such as DJ sets, concerts, and metaverse performances—rely on pre-programmed audio-visual content that does not respond dynamically to audience feedback. While visual projection systems and motion tracking have improved stage experiences, there remains no unified solution that continuously analyzes audience emotions or biometrics and translates them into real-time changes in audio, lighting, visuals, and tactile sensations. Therefore, there exists a need for a system that allows AI to interpret live audience reactions and instantly adjust the performance's sensory components, thereby merging human emotion, machine intelligence, and immersive technology into a single adaptive environment.

### SUMMARY OF THE INVENTION

The invention provides an AI-driven multi-sensory entertainment system that integrates real-time biometric sensing, haptic feedback, and AI-generated visuals and audio modulation to enhance user engagement during live or virtual events. The system operates as a closed feedback loop in which audience data—heart rate, motion, facial expression, and overall energy level—are analyzed by an AI engine that modifies music tempo, lighting dynamics, haptic vibration patterns, and AR/VR imagery to match collective and individual emotion in real time. The invention can be deployed in physical venues, hybrid installations, or fully virtual metaverse spaces. It establishes an adaptable performance architecture that unifies sensory perception across sound, vision, and touch.

### BRIEF DESCRIPTION OF THE DRAWINGS

FIG. 1—System architecture diagram showing connections between AI Engine, Biometric Sensors, AR/VR Visual Generator, and Haptic Devices.

FIG. 2—Real-time feedback loop illustrating how biometric data modifies audio, visual, and haptic layers.

FIG. 3—Multi-sensory synchronization layer showing coordination of sensory subsystems.

FIG. 4—Physical-virtual hybrid model depicting local and metaverse audience linkage.

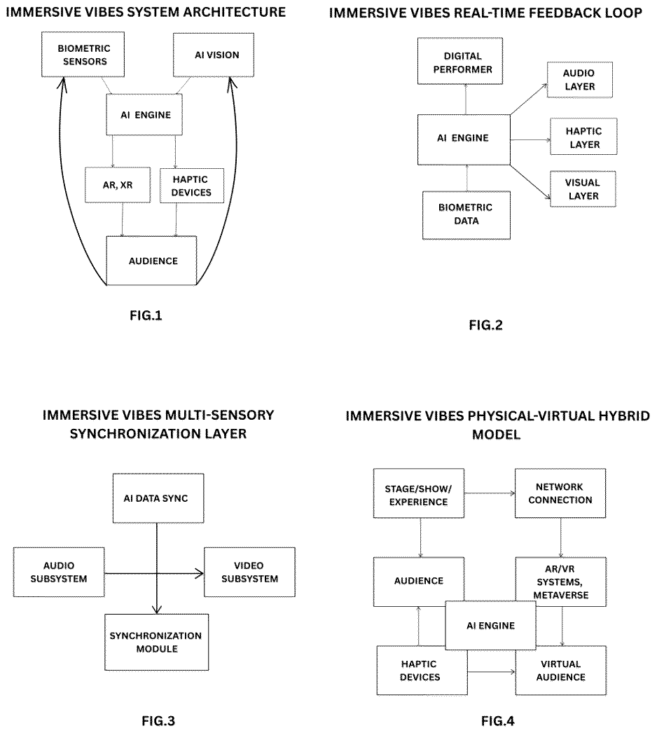

### DETAILED DESCRIPTION OF THE INVENTION

The Immersive Vibes AI and Haptic Powered Sensory System comprises a network of hardware and software modules that together create a responsive, data-driven entertainment environment. Core components include: an AI engine that analyzes audience biometric and behavioral data; biometric sensors that monitor heart rate, movement, and facial expression; AR/VR visual generators; haptic devices that produce synchronized vibration; and a control module that coordinates timing and data flow. The performer interface allows artists or DJs to influence AI parameters and override automation when desired.

Biometric Data Acquisition and Analysis. Audience biometric data are collected using optical sensors, wearables, or computer-vision cameras positioned in the venue. Parameters include heart rate, movement amplitude, gesture frequency, and facial expression categories (e.g., excitement, calm, surprise). Data streams are transmitted to the AI engine for continuous emotional classification. The engine employs neural networks trained on affective datasets to infer crowd mood and energy levels.

Real-Time Adaptive Feedback Loop. The AI engine dynamically adjusts performance variables according to the analyzed emotional state: music tempo, equalization, lighting brightness, color palette, and haptic vibration intensity. This feedback loop closes within milliseconds to ensure perceptual synchronization between audience emotion and sensory output.

AR/VR Visual Subsystem. The AR/VR visual generator synthesizes content in real time using procedural generation and AI-based animation. In physical venues, projections adapt to spatial geometry; in VR, three-dimensional worlds respond to collective or individual emotional energy. Visual themes, particle motion, and color dynamics evolve based on intensity derived from the biometric feedback layer.

Haptic Feedback Subsystem. The haptic subsystem translates musical frequencies and rhythmic patterns into tactile stimulation. Vibration motors or electro-active actuators embedded in wearable devices replicate bass impact or spatial motion. Intensity and pattern vary according to AI-determined excitement metrics, allowing users to feel the performance through touch.

Hybrid Physical-Virtual Architecture. A cloud-connected communication layer links physical events with metaverse environments. Data from local sensors feed both live venues and remote VR audiences, ensuring synchronized sensory experiences. The system can also deliver individualized sensory experiences to each participant based on personal biometric feedback.

Performer and System Interaction. Performers can influence the AI through a control dashboard, adjusting responsiveness, tempo bias, or visual themes. The system records anonymized analytics for post-event evaluation and future model training.

### INDUSTRIAL APPLICABILITY

The invention can be implemented in live concerts, festivals, immersive museums, gaming arenas, fitness and wellness environments, and virtual-reality platforms. It establishes a new paradigm for audience engagement through AI-mediated sensory synchronization.

### Advantages of the Invention

1. Real-time emotional adaptation of performances.
2. Unified control of sound, light, and touch.
3. Scalable to physical, virtual, or hybrid events.
4. Personalized sensory experiences for each participant.
5. New monetization models via licensing, NFTs, and sensory hardware.
6. Enhanced audience participation and immersion.

### Reference Numerals

1—AI Engine
2—Biometric Sensors
3—AR/VR Visual Generator
4—Haptic Devices
5—Control Module
6—Performer Interface
7—Audience
8—Network Link/Metaverse Bridge

### Conclusion

The Immersive Vibes—AI and Haptic Powered Sensory System integrates artificial intelligence, biometric feedback, and haptic technology into a single adaptive platform for entertainment and beyond. It enables performances that evolve in harmony with audience emotion, bridging the physical and virtual worlds to create a new category of responsive human-machine artistry.

1. A system for generating adaptive multi-sensory entertainment experiences, comprising: an artificial intelligence (AI) engine configured to receive real-time biometric and behavioral data from one or more audience members; a plurality of biometric sensors configured to detect at least one of heart rate, motion, facial expression, or emotion; a haptic feedback subsystem configured to produce tactile effects based on control signals from the AI engine; an augmented or virtual reality (AR/VR) visual generator configured to produce adaptive visual imagery; an audio modulation module configured to adjust one or more parameters of a music or sound stream; and a control module configured to synchronize output from the haptic feedback subsystem, AR/VR visual generator, and audio modulation module according to the AI engine's analysis of said biometric and behavioral data.

2. The system of claim 1, wherein the biometric sensors include wearable devices selected from the group consisting of vests, wristbands, gloves, or suits.

3. The system of claim 1, wherein the AI engine employs a neural network trained on emotional and physiological datasets to classify audience energy levels or mood states.

4. The system of claim 1, wherein the haptic feedback subsystem converts musical frequencies into corresponding vibration patterns applied to the audience members through the wearable devices.

5. The system of claim 1, wherein the control module maintains synchronization of sensory subsystems within a latency of less than 100 milliseconds.

6. The system of claim 1, wherein the AR/VR visual generator modifies at least one of color palette, brightness, image speed, or particle density based on the AI engine's emotional state output.

7. The system of claim 1, wherein the audio modulation module dynamically adjusts tempo, equalization, or harmonic intensity in response to real-time emotional feedback from the audience.

8. A hybrid physical-virtual entertainment platform comprising: a local event subsystem including sensors for collecting biometric and behavioral data from a live audience; a cloud-based AI engine configured to analyze said data in real time; a virtual event subsystem including networked AR/VR devices for remote audience members; and a synchronization layer configured to coordinate multisensory stimuli between the local event subsystem and the virtual event subsystem such that both physical and remote participants experience substantially simultaneous adaptive audiovisual and haptic outputs.

9. The platform of claim 8, wherein the synchronization layer employs network time protocol or equivalent latency-compensation algorithms to align sensory timing across geographically distributed systems.

10. The platform of claim 8, further comprising a performer control interface configured to adjust AI responsiveness or modify performance themes across both local and virtual environments.

11. The platform of claim 8, wherein audience data from both subsystems are aggregated to form a unified emotional feedback model for global adaptive performance control.

12. The platform of claim 8, further comprising a blockchain or digital-token authentication layer configured to verify participant identity or access to exclusive digital experiences.

13. The platform of claim 8, wherein the AI engine communicates adaptive control parameters to lighting, audio, and haptic systems via a standardized communication protocol.

14. The platform of claim 8, wherein biometric data are encrypted prior to transmission between the local subsystem and cloud-based AI engine.

15. A method for generating an AI-driven adaptive entertainment experience, comprising: collecting biometric and behavioral data from one or more participants using wearable or optical sensors; analyzing said data through an AI model trained to detect emotional states; modifying in real time the audio output, visual output, and haptic output of a performance based on the detected emotional states; and delivering synchronized multisensory stimuli to local and remote participants through networked haptic, audio, and AR/VR systems.
